(19) United States
(12) Patent Application Publication
(10) Pub. No.: US 2020/0250624 A1
(43) Pub. Date: Aug. 6, 2020

(54) COMMUNICATING DEVICE, COMMUNICATING SYSTEM, AND NON-TRANSITORY COMPUTER READABLE RECORDING MEDIUM STORING MAIL CREATING PROGRAM

(71) Applicant: KYOCERA Document Solutions Inc., Osaka (JP)

(72) Inventors: Takuya KOTSUJI, Osaka-shi (JP); Ryo SHIOMI, Osaka-shi (JP)

(73) Assignee: KYOCERA Document Solutions Inc., Osaka (JP)

(21) Appl. No.: 16/752,329

(22) Filed: Jan. 24, 2020

(30) Foreign Application Priority Data
Feb. 4, 2019 (JP) 2019-017844

(51) Int. Cl. G06Q 10/10; H04L 12/58

(52) U.S. Cl. CPC G06Q 10/107; H04L 51/16; H04L 51/22; H04L 51/02

(57) ABSTRACT

A communicating device of the present disclosure includes a mail receiving part and a mail creating part. The mail receiving part receives a received mail and stores the received mail in a received mail folder. The mail creating part creates a reply mail to a specified received mail in the received mail folder. The mail creating part searches the other received mail having the same title as the specified received mail from the received mail folder, and obtains main texts excluding a history portion from respective full texts of the specified received mail and the other received mail and adds the obtained main texts as a history to the reply mail.

### INCORPORATION BY REFERENCE

This application is based on and claims the benefit of priority from Japanese Patent application No. 2019-017844 filed on Feb. 4, 2019, the entire contents of which are incorporated herein by reference.

### BACKGROUND

The present disclosure relates to a communicating device creating a reply mail, a communicating system, and a non-transitory computer readable recording medium storing mail creating program.

In a communicating device, such as a personal computer or a smartphone, a software or an application (a mail creating program) creating, sending and receiving an email is installed. Such a mail creating program has various functions.

For example, there is a computer, such as a personal computer, executing a program stored in a recording medium to work as a schedule information extracting and editing device and automatically reflecting information related with a schedule included in electronic communication information, such as an e-mail, on the schedule.

Conventionally, the mail creating program has a function replying the email with a history (a reply function with a history). In the function replying the email with the history, for example, in a case where Mr. A sends the email with main text-a to Mr. B, Mr. C and Mr. D and Mr. B replies to this email, the main text-a of Mr. A is added to a reply mail of Mr. B as a history-a. Therefore, because the reply mail of Mr. B includes main text-b of Mr. B and the history-a, the history-a, i.e. the main text-a of Mr. A, can be confirmed just by seeing the reply mail of Mr. B without seeing the email of Mr. A. Similarly, in a case where Mr. C replies to the email of Mr. A, a reply mail of Mr. C includes main text-c of Mr. C and the history-a.

In a case where Mr. D replies to the email of Mr. B, not only the history-a of Mr. A but also the main text-b of Mr. B as a history-b are added to a reply mail of Mr. D. Therefore, the reply mail of Mr. D includes main text-d of Mr. D and the history-a and the history-b so that they can be collectively confirmed. However, because the reply mail of Mr. D lacks a history-c of Mr. C, the main text-c of Mr. C cannot be confirmed by the reply mail of Mr. D. Further, if discussion of Mr. A, Mr. B, Mr. C and Mr. D is carried out subsequently to replying to the reply mail of Mr. D, the discussion is proceeded while lacking information of the main text-c of Mr. C.

Thus, if different reply mails are sent with regard to one email shared by several persons, because the reply mails are branched off, it is feared that, if several emails are not seen, information of all the emails cannot be confirmed.

### SUMMARY

A communicating device of the present disclosure includes a mail receiving part and a mail creating part. The mail receiving part receives a received mail and stores the received mail in a received mail folder. The mail creating part creates a reply mail to a specified received mail in the received mail folder. The mail creating part searches the other received mail having the same title as the specified received mail from the received mail folder, and obtains main texts excluding a history portion from respective full texts of the specified received mail and the other received mail and adds the obtained main texts as a history to the reply mail.

A communicating system of the present disclosure includes the above-described communicating device and a mail server communicably connected to the communicating device.

A recording medium a non-transitory computer readable recording medium stores mail creating program of the present disclosure. The mail creating program makes a computer of a communicating device execute, when creating a reply mail to a specified received mail in a received mail folder, a step of searching the other received mail having the same title as the specified received mail from the received mail folder, and obtaining main texts excluding a history portion from respective full texts of the specified received mail and the other received mail and adding the obtained main texts as a history to the reply mail.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a block diagram showing a communicating system according to an embodiment of the present disclosure.

FIG. 2 is a plane view showing a mail creating screen in a communicating device according to the embodiment of the present disclosure.

FIG. 3 is a plane view showing a switching screen for a function replying an email with a history in the communicating device according to the embodiment of the present disclosure.

FIG. 4 is a plane view showing a setting screen for merging quotation in the communicating device according to the embodiment of the present disclosure.

FIG. 5 is an explanatory drawing schematically showing an example of a received mail in the communicating device according to the embodiment of the present disclosure.

FIG. 6 is an explanatory drawing schematically showing one example of a reply mail in the communicating device according to the embodiment of the present disclosure.

FIG. 7 is an explanatory drawing schematically showing the other example of the reply mail in the communicating device according to the embodiment of the present disclosure.

FIG. 8 is an explanatory drawing schematically showing an example of a further reply mail in the communicating device according to the embodiment of the present disclosure.

### DETAILED DESCRIPTION

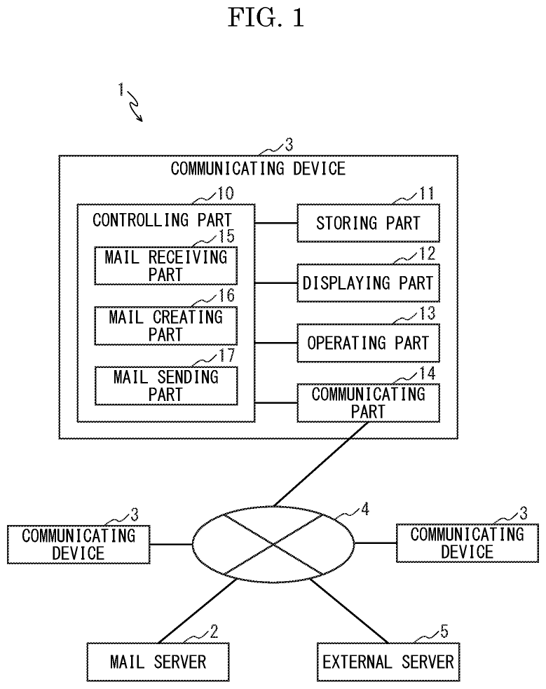

First, entire structure of a communicating system 1 according to an embodiment of the present disclosure will be described with reference to FIG. 1.

The communicating system 1 includes a mail server 2 and a plurality of communicating devices 3, and the mail server 2 and the plurality of communicating devices 3 are communicably connected to each other via a network 4, such as an internet or a LAN (Local Area Network). In FIG. 1, although one mail server 2 is illustrated, the communicating system 1 may include two or more mail servers 2. Moreover, in FIG. 1, although three communicating devices 3 are illustrated, the communicating system 1 may include two communicating devices 3 or four or more communicating devices 3.

The mail server 2 may be a server exclusive to the network 4 constructed for an organization, such as an office or a school, or may be a server provided in a provider on the network 4 of the internet.

The communicating device 3 is a device, such as a personal computer, a smartphone or a multifunction peripheral. The communicating device 3 is connected to the network 4 by wired or wireless, and further, is connected to the mail server 2 via the network 4. The plurality of communicating devices 3 have functions mutually sending and receiving emails via the mail server 2. The plurality of communicating devices 3 may uses the same mail server 2 or may use different mail servers 2.

The communicating device 3 includes, as shown in FIG. 1, a controlling part 10 composed of a CPU (Central Processing Unit) or the like, and a storing part 11 composed of a ROM (Read Only Memory), a RAM (Random Access Memory), a hard disc and others. The storing part 11 is a non-transitory recording medium readable by the computer to store control program and control data controlled by the controlling part 10. Incidentally, in FIG. 1, although detail structure of one communicating device 3 is illustrated, the other communicating devices 3 have the similar structure.

Moreover, the communicating device 3 includes a displaying part 12, an operating part 13 and a communicating part 14. The controlling part 10 controls the displaying part 12, the operating part 13 and the communicating part 14 on the basis of the control program and the control data stored in the storing part 11. The controlling part 10 works as a mail receiving part 15, a mail creating part 16 and a mail sending part 17 by executing mail creating program stored I the storing part 11. That is, the communicating device 3 includes the mail receiving part 15, the mail creating part 16 and the mail sending part 17. The mail creating program makes the CPU (the computer) of the communicating device 3 execute respective processes (steps) and is composed of a software operating on the personal computer, an application operating on the smartphone or the like.

The displaying part 12 is composed of a display device, such as a liquid crystal display or the like, and is controlled by the controlling part 10 to display respective kinds of screens. The operating part 13 is composed of an input device, such as a keyboard, a pointing device or the like, and receives operation of a user and transmits this operation to the controlling part 11. Incidentally, the displaying part 12 and the operating part 13 may be composed of a liquid crystal panel and a touch pad, and thereby, composed as an integrated touch panel.

The communicating part 14 is an interface communicably connecting the communicating device 3 to the network 4 by wired or wireless. While the communicating device 3 is activated, the communicating part 14 automatically connects to the network 4 to communicably connect to the mail server 2.

Next, the mail creating program including the mail receiving part 15, the mail creating part 16 and the mail sending part 17 will be described. the mail creating program stores a received email (a received mail) or a compression data of the received mail in a received mail folder of the storing part 11 and stored a sent email (a sent mail) or a compression data of the sent mail in a sent mail folder of the storing part 11.

Moreover, the mail creating program stores an address book in the storing part 11. In the address book, destination information of one or more destinations is stored and the destination information includes, for example, a destination name, a mail address, an address and others. The mail creating program can not only refer to the address book but also can edit the address book.

The mail receiving part 15 issues mail reception inquiry to the mail server 2 via the communicating part 14 at regular intervals or in accordance with operation of the user and automatically receives the email including the destination of this communicating device 3 from the mail server 2. The mail receiving part 15 stores the received mail from the mail server 2 in the received mail folder or its lower folder of the storing part 11. A folder for storing the received mail may be previously set or may be determined in accordance with operation of the user after receiving.

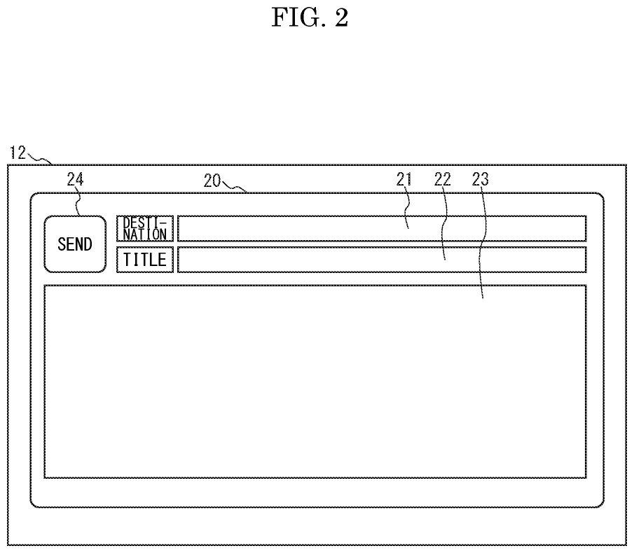

The mail creating part 16 creates a new mail, or a reply mail or a transfer mail to the received mail in accordance with operation of the user. The user of this communicating device 3 becomes a sender of the reply mail or the transfer mail. On a main screen (not shown) of the mail creating program, when new mail creation operation, reply operation or transfer operation for the email is carried out, the mail creating part 16 displays, as shown in FIG. 2, a mail creating screen 20 on the displaying part 12. On the mail creating screen 20, a destination input column 21, a title input column 22 and a main text input column 23 are displayed so as to enable to input the destination (the mail address), a title and main text, respectively. On the mail creating screen 20, in addition to input of the destination, the title and the main text, an attachment file can be selected.

To the destination input column 21, the destination may be directly inputted in accordance with operation of the user, or the destination may be selected from the address book stored in the storing part 11. Incidentally, when creating the reply mail, the mail creating part 16 may automatically input the sender and the destination of the received mail to the destination input column 21 as the destination of the reply mail in accordance with setting and, even in such a case, the destination input column 21 may receive further editing of the destination.

In the title input column 22, the title is inputted in accordance with operation of the user. Incidentally, when creating the reply mail, the mail creating part 16 may automatically input the title of the received mail or the title made by adding an additional character to the title of the received mail to the title input column 22 as the title of the reply mail in accordance with setting and, even in such a case, the title input column 22 may receive further editing of the title. The additional character will be described later.

In the main text input column 23, the main text composed of a sentence or the like is inputted in accordance with operation of the user. Incidentally, when creating the reply mail, the mail creating part 16 may perform a function replying the email with a history in accordance with setting. In the function replying the email with the history, the main text of the received mail, or the main text of the received mail and the main text of the other email related to the received mail is/are automatically quoted to the reply mail as the history and automatically inputted to the main text input column 23. Even if the history is quoted, the main text input column may be further edited. A detail of the function replying the email with the history in the mail creating part 16 will be described later.

The mail sending part 17 sends the email, such as the new mail, the replay mail or the transfer mail, in accordance with operation of the user. For example, on the mail creating screen 20 for the email, a sending key 24 is displayed and, when the sending key 24 is operated, the mail creating part 16 specifies the email being created on the mail creating screen 20 and the mail sending part 17 performs sending of the email. Alternatively, when saving operation for the email being created on the mail creating screen 20, the mail creating part 16 saves the email being created on the mail creating screen 20 in a draft folder of the storing part 11. On the main screen (not shown) of the mail creating program, a sending/receiving key (not shown) is displayed and, when the sending/receiving key is operated, the mail sending part 17 performs sending of the email in the draft folder.

At this time, the mail sending part 17 sends the email to the mail server 2 via the communicating part and, then sending is succeeded (for example, sending success notification is received from the mail server 2), the sent mail is saved in the sent mail folder or its lower folder of the storing part 11. A folder for storing the sent mail may be previously set or may be determined in accordance with operation of the user after sending.

Next, the function replying the email with the history in the mail creating part 16 will be described in detail. When creating the reply mail to a predetermined received mail, the mail creating part 16 works as the function replying the email with the history of any one of “received mail quotation”, “merging quotation” and “non-quotation”.

In a case of the “received mail quotation”, the mail creating part 16 adds full text of the received mail as the history to the reply mail. Incidentally, the full text of the received mail includes an input portion inputted and a history portion quoted when creating the received mail.

In a case of the “merging quotation”, the mail creating part 16 made the history by merging the main text (the input portion excluding the history portion from the full text) of the received mail and the main text (the input portion excluding the history portion from the full text) of the other email related to the received mail and adds the history to the reply mail. Incidentally, the mail creating part 16 searches the related email by the email having the same title as the received mail from the received mail folder the storing part 11, but may designate a searching object by a folder directed from the lower folder of the received mail folder by the user.

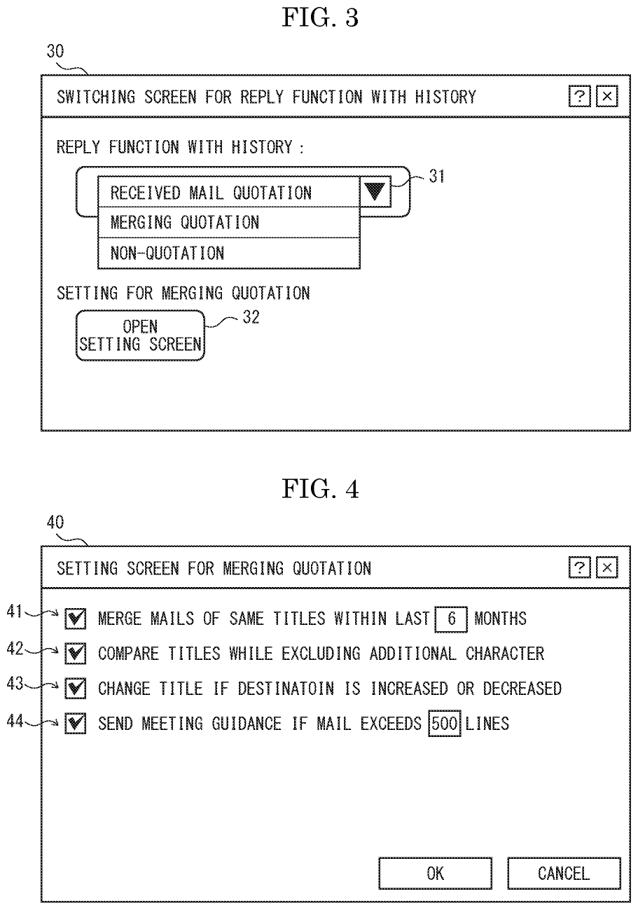

When setting operation of the function replying the email with the history on the main screen (not shown) of the mail creating program is carried out, the mail creating program displays a switching screen 30 (refer to FIG. 3) of the function replying the email with the history on the displaying part 12 and receives switching of the function replying the email with the history via the switching screen 30. The switching screen 30 includes a switching key 31 for the function replying the email with the history and a displaying key 32 for a setting screen 40 (refer to FIG. 4) for various settings of the “merging quotation”.

The switching key 31 is composed of a pull-down menu or the like so as to receive switching of the “received mail quotation”, the “merging quotation” and the “non-quotation”. In a case where the “received mail quotation” or the “non-quotation” is set by the switching key 31, the displaying key 32 becomes an operation disabled state, or in a case where the “merging quotation” is set by the switching key 31, the displaying key 32 becomes an operation enabled state.

When the displaying key 32 of the switching screen 30 is operated, the setting screen 40 for various settings of the “merging quotation” is displayed on the displaying part 12. The mail creating program receives various settings of the “merging quotation” via the setting screen 40 and store various settings in the storing part 11. The setting screen 40 displays, as shown in FIG. 4, a history range key 41, an additional character excluding key 42, a reply title changing key 43 and a meeting guidance key 44.

The history range key 41 is composed of a check box or the like for setting ON or OFF of a history range with regard to whether or not an addition range restricting the history added to the received mail is provided. In a case where the history range is ON, the history is added to the reply mail within the directed addition range, or in a case where the history range is OFF, the history is added to the reply mail regardless of the addition range.

The addition range of the history is set by a predetermined elapsed period going back from creation date of the reply mail, and the email at a date (a sent date or a received date) within the elapsed period becomes an object of the added history. Alternatively, the addition range of the history is not restricted by the elapsed period, may be set by a predetermined number of the emails going back from creation date of the reply mail and the number of the emails becomes the object of the history or may be set by a predetermined number of lines in the reply mail. Moreover, the history range key 41 may include a text box for inputting and setting the elapsed period, the number of the emails, the number of the lines being the added range.

The additional character excluding key 42 is composed of a check box or the like for setting ON or OFF of additional character excluding with regard to whether or not the titles are compared while excluding the additional character when searching the email having the same title as the received mail. In a case where the additional character excluding is ON, the email having the same title as the received mail is searched while excluding the additional character from the title, or in a case where the additional character excluding is OFF, the email having the same title as the received mail is searched while including the additional character (without excluding the additional character).

For example, in the reply mail or the transfer mail, to an original title, the additional character, such as “Re:” or “Fw:” may be automatically added or the additional character, such as “[Resending]” or “[Response]” may be optically added by the user. In the case where the additional character excluding is ON, the titles are compared while excluding such an additional character. Moreover, the additional character excluding key 42 may include a text box for inputting and setting the excluding additional character.

The reply title changing key 43 is composed of a check box or the like for setting ON or OFF of reply title changing with regard to whether or not changing the title when the destination (excluding the sender of the reply mail) of the reply mail to members composed of the sender and the destination of the received mail is increased or decreased. In a case where the reply title changing is ON, increasing or decreasing of the destination of the reply mail is decided when performing sending of the reply mail and, when such increasing or decreasing has been carried out, a confirming screen (not shown) indicating increasing or decreasing of the destination is displayed on the displaying part 12 to notify the user of increasing or decreasing of the destination and to urge the user to change the title. At this time, the mail creating part 16 may automatically change the title of the reply mail and display the changed title on the confirming screen or may make the user input the changed title via the confirming screen.

For example, while several specific members exchange the email having a content intended to disclosure for only members, such as a content having high security or a content having high confidentiality, the other member may be added to the destination of the reply mail. In such a case, when the reply title changing is ON, because an opportunity to change the title of the reply mail is given, that is, an opportunity to decide whether or not the preceding email ever exchanged is added as the history to the reply mail is given.

Thus, by using a timing of destination changing to select presence or absence of changing of the title of the reply mail, the sender of the reply mail can select whether or not the history of the preceding email is disclosed to the changed destination. For example, in a case where it is not desired that the content of the preceding mail is known to the other member new added to the destination of the reply mail, it is possible to prevent the history of the preceding email from automatically being added to the reply mail by changing the title of the reply mail. Therefore, it is possible to restrain the history of the preceding email from being unnecessarily disclosed.

Incidentally, changing of the title of the reply mail is not restricted by an example of a case where increasing or decreasing of the destination is carried out. For example, in a case where a predetermined number or more of the emails (the email having a related title) are exchanged, there is a possibility that the title and the content of the main text are deviated from each other. In such a case, the mail creating part 16 displays a confirming screen (not shown) indicating the fact that the predetermined number or more of the emails are exchanged on the displaying part 12 when creating the reply mail to notify the user of that fact and to urge the user to change the title.

For example, in a case where the discussion about a predetermined discussed point or theme by exchanging the emails having the title related to the discussed point or the theme, the discussed point or the theme may be changed when the discussion is proceeded. When the discussed point or the theme is thus changed, because it is considered that the emails are exchanged over multiple times, by giving the opportunity to change the title of the reply mail, it is possible to give an opportunity to reconsider the discussed point or the theme. Further, it is possible to give an opportunity to decide whether or not adding the preceding email ever exchanged as the history to the reply mail. For example, the sender of the reply mail can intentionally change the title of the reply mail, and thereby, can prevent the history of the preceding email from being automatically added and can delete a topic having low relativity from the content of the email.

The meeting guidance key 44 is composed of a check box or the like for setting ON or OFF of meeting guidance with regard to whether or not creating the meeting guidance to the user (the sender of the reply mail) and the destination of the reply mail when the history of the reply mail exceeds a predetermined of addition quantity. In a case where the meeting guidance is ON, when performing sending of the reply mail, if the history (or the full text) of the reply mail exceeds the predetermined of addition quantity, the mail creating part 16 notifies the user of excess of the addition quantity of the history via the displaying part 12, and creates the meeting guidance to the user and the destination of the reply mail or directs the user to create the meeting guidance.

The addition quantity of the history is set, for example, by a predetermined number of lines in the reply mail or by a predetermined number of the emails going back from creation date of the reply mail (a predetermined number of the emails). Moreover, the meeting guidance key 44 may include a text box for inputting and setting the number of the emails, the number of the lines being the addition quantity.

As one example of meeting guidance creating, for example, when the user and the destination of the reply mail use synchronous schedule managing software, the mail creating part 16 searches a date having no plan and being common to the user and the destination from the schedule managing software. Subsequently, the mail creating part 16 registers the meeting guidance at the date as a searched result to the schedule managing software and notifies the user and the destination of the meeting guidance via the schedule managing software.

As the other example of meeting guidance creating, the mail creating part 16 displays a creating screen (not shown) for the meeting guidance on the displaying part 12 to notify the user of excess of the addition quantity of the history and to urge the user to create the meeting guidance. Incidentally, the mail creating part 16 may create the meeting guidance or may direct the user to create the meeting guidance on the condition that a predetermined number of the emails (the email having a related title) are exchanged among a predetermined number of the members within a predetermined period (or on the condition of at least one out of the predetermined number of the emails, the predetermined number of the members and the predetermined period.

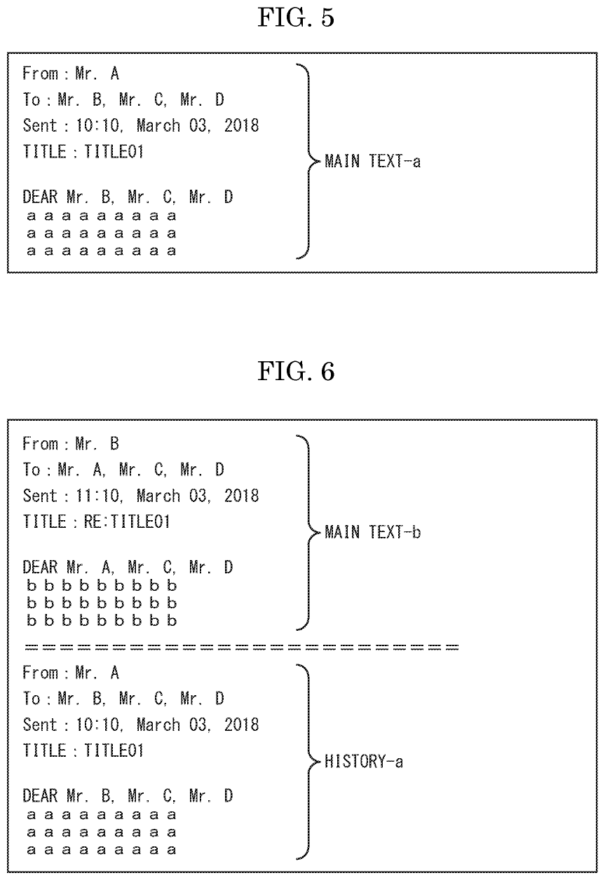

Next, an example of an operation for creating the reply mail by the merging quotation of the function replying the email with the history will be described. First, as shown in FIG. 5, Mr. A as the sender sends the email with main text-a to Mr. B, Mr. C and Mr. D as the destination. That is, the email of the main text-a of Mr. A is an original mail.

Subsequently, as shown in FIG. 6, Mr. B creates and sends the reply mail to the email of Mr. A with adding the destination of Mr. C and Mr. D. At this time, in the reply mail of Mr. B, main text-b of Mr. B is inputted, and further, the main text-a of Mr. A is added as the history-a. That is, since the reply mail of Mr. B includes the main text-b of Mr. B and the history-a, it is possible to confirm the main text-a of Mr. A just by seeing the reply mail of Mr. B without seeing the email of Mr. A.

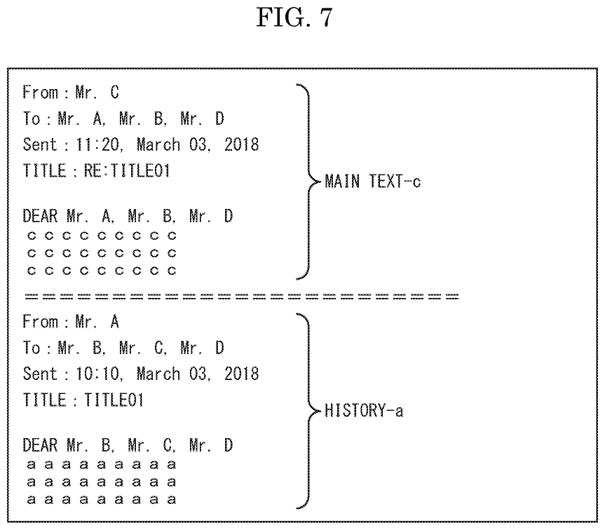

Similarly, as shown in FIG. 7, Mr. C creates and sends the reply mail to the email of Mr. A with adding the destination of Mr. B and Mr. D. At this time, in the reply mail of Mr. C, main text-c of Mr. C is inputted, and further, the main text-a of Mr. A is added as the history-a. That is, the reply mail of Mr. C includes the main text-c of Mr. C and the history-a.

An example of an operation when Mr. D here creates and sends the reply mail to the email of Mr. B to the destination of Mr. A, Mr. B and Mr. C by using the communicating device 3 will be described. Incidentally, in the communicating device 3 of Mr. D, the email of Mr. A, the email of Mr. B and the email of Mr. C described above are stored as the received mails in the received mail folder of the storing part 11 in a time series of this order. Moreover, in this communicating device 3, the switching key 31 on the switching screen 30 for the function replying the email with the history is set to ON and the history range key 41, the additional character excluding key 42, the reply title changing key 43 and the meeting guidance key 44 on the setting screen 40 for the merging quotation are set to ON.

In a case of creating the reply mail to the email of Mr. B, the mail creating part 16 of the communicating device 3 firstly searches the received mail having the same title as the email of Mr. B from the received mail folder. The email of Mr. B is the reply mail to the email of Mr. A and the title of the email of Mr. B has been named by adding the additional character “Re:” to the title of the email of Mr. A. Moreover, the title of the email of Mr. C also has been named by adding the additional character “Re:” to the title of the email of Mr. A. Therefore, in the communicating device 3 of Mr. D, since the additional character excluding is set to ON, it is decided that all the emails of Mr. A, Mr. B and Mr. C have the same title.

Next, the mail creating part 16 obtains the main texts excluding the history portions from the email of Mr. A, the email of Mr. B and the email of Mr. C. Because the email of Mr. A does not include the history, the main text-a is obtained from the email of Mr. A. Although the email of Mr. B includes the history-a, the main text-b is obtained from the email of Mr. B. Although the email of Mr. C includes the history-a, the main text-c is obtained from the email of Mr. C.

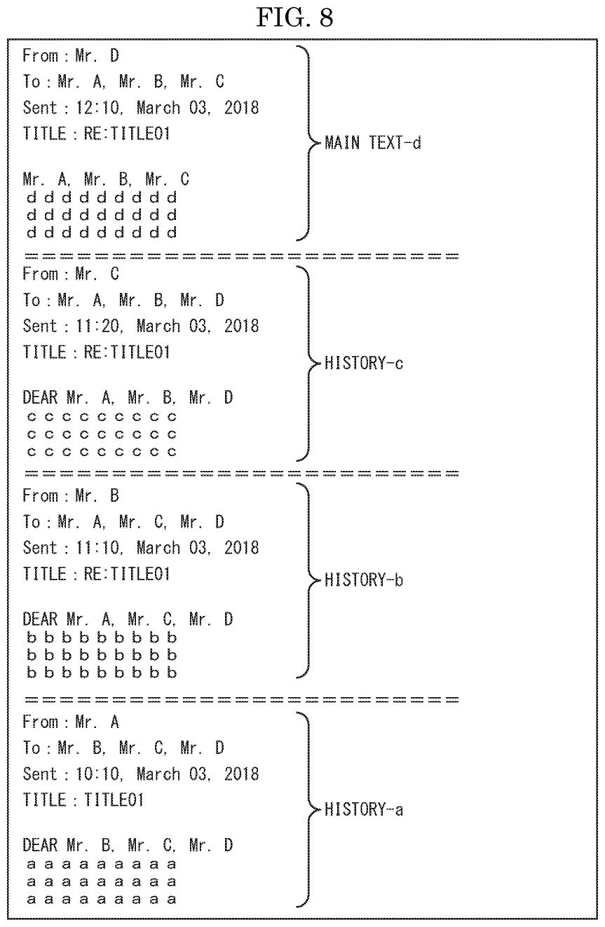

The mail creating part 16 inputs the main text-a, the main text-b and the main text-c thus obtained as the history-a, the history-b and the history-c in the main text input column 23 in a time series order. In the main text input column 23, in an order of a date (the sent date or the received date), the oldest history-a is inputted at a lowermost side and the newest history-c is inputted at an uppermost side. Moreover, in the main text input column 23, the main text-d can be inputted in accordance with operation of the operating part 13 by Mr. D. The thereby created and sent reply mail includes, as shown in FIG. 8, the main text-d, the history-a, the history-b and the history-c.

Thus, even if Mr. B and Mr. C respectively send the different reply mails branched off to the original email of Mr. A, the communicating device 3 adds the main text-a, the main text-b and the main text-c specific to the respective mails as the history-a, the history-b and the history-c to the reply mail.

In accordance with the embodiment, as described above, the communicating device 3 includes the mail receiving part 15 receiving the received mail and storing the received mail in the received mail folder of the storing part 11, and the mail creating part 16 creating the reply mail to the specified received mail in the received mail folder. the mail creating part 16 searches the other received mail having the same title as the specified received mail from the received mail folder, and obtains the main texts excluding the history portion from the respective full texts of the specified received mail and the other received mail and adds the obtained main texts as the history to the reply mail.

Thereby, in accordance with the communicating device 3 of the embodiment, regardless branching-off of the reply mails in progress, since the replay mail is created by adding the contents of all the related emails without overlapping or lacking (losing), it is possible to collectively confirm the contents of all the related emails.

Incidentally, although, in the above-described embodiment, an example of the condition of the related email that the related email has the same title as the original received mail, in the merging quotation of the function replying the email with the history, in which the main text of the other email related to the original received mail is merged and added as the history to the reply mail, is described, the present disclosure is not limited by this example.

For example, in another embodiment, the condition of the related email may be that the member composed of the sender and the destination of the related email is the same as the original received mail in addition that the title of the related email is the same as the original received mail. Concretely, when creating the reply mail, the mail creating part 16 searches the email having the same title as the received mail and being exchanged among the same member as the received mail from the received mail folder of the storing part 11. Subsequently, the mail creating part 16 quotes the main text of the received mail and the main text of the email of as a searched result as the history to the reply mail.

Thereby, since the email related to the reply mail is decided on the condition of not only the title but also the member of the sender and the destination, it is possible to prevent the history of a not-related email from being added to the reply mail in error. Moreover, if the mail creating part 16 searches the email (a different member mail) having the same title as the received mail and being exchanged among the different member from the received mail from the received mail folder of the storing part 11, the mail creating part 16 may display an inquiry screen (not shown) for inquiring whether or not adding the history of the different member mail to the reply mail on the displaying part 12 to notify the user of presence of the different member mail and make the user select whether or not adding the history of the different member mail.

In addition, the mail creating part 16 of the communicating device 3 decides whether or not the titles of the specified received mail and the other received mail are the same while excluding the additional character to the title of the original received mail, in the merging quotation of the function replying the email with the history. Thereby, it is possible to collect all the related emails in a lump without restricting the title.

Further, the mail creating part 16 of the communicating device 3 restricts the history added to the reply mail to a predetermined addition range, in the merging quotation of the function replying the email with the history. Thereby, even if the reply mails related due to the original mail are stored in great numbers, it is possible to create the reply mail without making the history redundant.

Moreover, the mail creating part 16 of the communicating device 3 is configured to include the check box or the like for setting ON or OFF of the reply title changing with regard to whether or not changing the title when the destination of the reply mail to the received mail is increased or decreased, in the merging quotation of the function replying the email with the history. In the case where the reply title changing is ON, increasing or decreasing of the destination of the reply mail is decided when performing sending of the reply mail and, when such increasing or decreasing has been carried out, the confirming screen (not shown) indicating increasing or decreasing of the destination is displayed on the displaying part 12 to notify the user of increasing or decreasing of the destination and to urge the user to change the title. At this time, the mail creating part 16 may automatically change the title of the reply mail and display the changed title on the confirming screen or may make the user input the changed title via the confirming screen.

Furthermore, if the history added to the reply mail exceeds the predetermined of addition quantity, the mail creating part 16 of the communicating device 3 creates the meeting guidance to the sender and the destination of the reply mail or directs the sender to create the meeting guidance. Thereby, in a case where the reply mails related due to the original mail become in great numbers and convergence of discussion is not expected, by creating the meeting guidance and urging to hold meeting, it is possible to reduce time required for meeting guidance creating and to converge the discussion.

Incidentally, the mail creating program of the communicating device 3 can set various options for the merging quotation of the function replying the email with the history. As one example of the option, the mail creating part 16 may indicate the history added to the reply mail by a different font (a font type, a color and others) from the main text. In such a case, the font for the history may be previously set or may optionally be set in accordance with operation of the user. Moreover, in a case where the different fonts are set for respective users, when inputting the history, the font set to the sender (the user) of the original email being the base of the history may be applied. Thereby, it is possible for the user to easily visually recognize the main text and the history portion of the reply mail.

As another example of the option, if sending of the created reply mail is performed, the mail creating part may display a confirming screen (not shown) for confirming with the user (the sender) whether or not sending of the created reply mail is allowed on the displaying part 12. In such a case, on the confirming screen, a preview of the reply mail may be displayed and, in the preview, the inputted main text may be emphasized in order to make the user confirm the main text or the history inputted regardless intention of the user may be emphasized in order to make the user confirm the history.

As a further example of the option, if the history added to the reply mail exceeds the predetermined of addition quantity, the mail creating part 16 may create an email (a history mail), electronic data (a history file), such as a text file, or the like in which the history is inputted. The mail creating part 16 stores the created history mail or the created history file in an external server 5 (refer to FIG. 1) and obtains a link of the history mail or the history file in the external server 5. Subsequently, the mail creating part 16 inputs the link of the history mail or the history file to the reply mail without adding the history to the reply mail. Moreover, if an attachment file is included in the received fail, the mail creating part 16 stores the attachment file as a history attachment file to the external server 5 and obtains a link of the history attachment file in the external server 5. Subsequently, the mail creating part 16 inputs the link of the history attachment file or the history attachment file to the reply mail without adding the history attachment file to the reply mail.

Incidentally, in the above-described embodiment, an example of the mail creating part 16 providing the meeting guidance as a discussing way other than the email, if the history added to the reply mail exceeds the predetermined of addition quantity, is described, the discussing way other than the email is not limited by this example. For example, the mail creating part 16 may use a communication tool in a chat system (i.e. a chat tool), such as Skype or LINE, installed in the communicating device 3 as the discussing way other than the email. In such a case, the communication tool is installed in the respective communicating devices 3 for the sender and the destination to the reply mail. Moreover, in the communication tool, contact information of chat-communicable destination is registered in a contact information list and it is desired that the contact information list is synchronized with the address book of the mail creating program.

The mail creating part 16 notifies the user (the sender of the reply mail) of creating of a chat group in the communicating tool, if the history added to the reply mail exceeds the predetermined of addition quantity. For example, the mail creating part 16 starts the communicating tool of the communicating device 3 and searches the contact information of the sender and the destination of the reply mail from the contact information list. The mail creating part 16 makes the communicating tool create the chat group composed of the sender and the destination of the reply mail on the basis of the searched contact information. Alternatively, the mail creating part directs the user to create the chat group of the communicating tool.

Incidentally, although the above-described embodiments have described about one example of the non-transitory computer readable recording medium storing the mail creating program according to the present disclosure, the communicating device 3 and the communicating system 1, the technical scope of the present disclosure is not limited to the embodiments.

Although, in the above-described embodiments, a case where a configuration of the present disclosure is applied in the communicating device 3, such as a personal computer, a smartphone or a multifunction peripheral, the non-transitory computer readable recording medium storing the mail creating program of the communicating device 3, and the communicating system 1 including the communicating device 3 is described, in a different embodiment, the configuration of the present disclosure may be applied in the non-transitory computer readable recording medium storing the mail creating program installed in the other device, the other device including the mail creating program or the other system including the communicating device.

1. A communicating device comprising:
a mail receiving part receiving a received mail and storing the received mail in a received mail folder; and
a mail creating part creating a reply mail to a specified received mail in the received mail folder,
wherein the mail creating part searches the other received mail having the same title as the specified received mail from the received mail folder, and obtains main texts excluding a history portion from respective full texts of the specified received mail and the other received mail and adds the obtained main texts as a history to the reply mail.

2. The communicating device according to claim 1, wherein
the mail creating part decides that the other received mail is an email having the same title as the specified received mail and being exchanged among the same member composed of destination and a sender as the specified received mail.

3. The communicating device according to claim 1, wherein
the mail creating part decides whether or not titles of the specified received mail and the other received mail are the same while excluding an additional character to a title of an original received mail.

4. The communicating device according to claim 1, wherein
the mail creating part restricts the history added to the reply mail to a predetermined addition range.

5. The communicating device according to claim 1, wherein
the mail creating part enables to change a title of the reply mail in a case where increasing or decreasing of destination of the reply mail is carried out with regard to a member composed of destination and a sender as the specified received mail.

6. The communicating device according to claim 1, wherein
the mail creating part creates meeting guidance to a sender and destination of the reply mail or direct the sender to create the meeting guidance if the history added to the reply mail exceeds a predetermined of addition quantity.

7. The communicating device according to claim 1, wherein
with regard to an email having the same title as the specified received mail and being exchanged among a different member from the specified received mail, the mail creating part displays an inquiry screen for inquiring whether or not adding the history of the email to the reply mail on a displaying part.

8. The communicating device according to claim 1, wherein
if sending of the created reply mail is performed, the mail creating part displays a preview of the reply mail on a displaying part and, in the preview, emphasizes the main text or emphasizes the history.

9. The communicating device according to claim 1, wherein
if the history added to the reply mail exceeds a predetermined of addition quantity, the mail creating part creates a history mail or a history file, in which the history is inputted, stores the history mail or the history file in an external server, obtains a link of the history mail or the history file in the external server, and inputs the link of the history mail or the history file to the reply mail without adding the history to the reply mail.

10. A communicating system comprising:
a communicating device according to claim 1; and
a mail server communicably connected to the communicating device.

11. A non-transitory computer readable recording medium storing mail creating program,
wherein the mail creating program makes a computer of a communicating device execute:
when creating a reply mail to a specified received mail in a received mail folder, a step of searching the other received mail having the same title as the specified received mail from the received mail folder, and obtaining main texts excluding a history portion from respective full texts of the specified received mail and the other received mail and adding the obtained main texts as a history to the reply mail.
